(19) United States
(12) Patent Application Publication
(10) Pub. No.: US 2025/0102616 A1
(43) Pub. Date: Mar. 27, 2025

(54) PSEUDO-MONOSTATIC SENSING MODE BASED RF SENSING

(71) Applicant: Samsung Electronics Co., Ltd., Suwon-si (KR)

(72) Inventors: Guanbo Chen, Mckinney, TX (US); Songwei Li, Mckinney, TX (US); Yuming Zhu, Plano, TX (US); Vishnu Vardhan Ratnam, Frisco, TX (US)

(21) Appl. No.: 18/821,948

(22) Filed: Aug. 30, 2024

Related U.S. Application Data
(60) Provisional application No. 63/540,296, filed on Sep. 25, 2023.
(60) Provisional application No. 63/624,634, filed on Jan. 24, 2024.

(51) Int. Cl. G01S 7/00; G01S 7/41; G01S 13/52; H04W 24/02; H04W 84/12

(52) U.S. Cl. CPC G01S 7/006; G01S 7/415; G01S 13/52; H04W 24/02; H04W 84/12

(57) ABSTRACT

A computer-implemented method for multi-device sensing at a first device in a wireless network, comprising: determining, by the first device, whether the first device operates in a mode in which the first device and a second device coordinate to simultaneously transmit and receive radio frequency (RF) signals and the first device is within a distance of the second device, exchanging, by the first device, RF signals with the second device, obtaining, by communicating with the second device, signal information from the exchanged RF signals, and performing sensing based on the signal information

### CROSS-REFERENCE TO RELATED APPLICATIONS

This application claims the benefit of priority from U.S. Provisional Application No. 63/540,296 entitled “Method and Apparatus of Pseudo-Monostatic Sensing Mode Based RF Sensing” filed Sep. 25, 2023, and U.S. Provisional Application No. 63/624,634 entitled “Pseudo-Monostatic Sensing Mode Based RF Sensing” filed Jan. 24, 2024, all of which are incorporated herein by reference in their entireties.

### TECHNICAL FIELD

This disclosure relates generally to a radio frequency (RF) sensing, and more particularly to, for example, but not limited to, pseudo-monostatic sensing mode based RF sensing.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

RF sensing is playing an important role in consumer electronics today. Compared with other electromagnetic sensors such as camera, infrared, lidar, among others, RF sensors have the advantage of being able to protect user privacy and being low cost.

The description set forth in the background section should not be assumed to be prior art merely because it is set forth in the background section. The background section may describe aspects or embodiments of the present disclosure.

### SUMMARY

One aspect of the present disclosure provides a computer-implemented method for multi-device sensing at a first device in a wireless network. The method comprises determining, by the first device, whether the first device operates in a mode in which the first device and a second device coordinate to simultaneously transmit and receive radio frequency (RF) signals and the first device is within a distance of the second device. The method comprises exchanging, by the first device, RF signals with the second device. The method comprises obtaining, by communicating with the second device, signal information from the exchanged RF signals. The method comprises performing sensing based on the signal information.

In some embodiments, the performing sensing comprises detecting motion and breathing rate of a human from the signal information, and estimating a sleep status based on the detected motion and breathing rate of the human.

In some embodiments, the performing sensing comprises detecting motion of a human indicative of exercising from the signal information, extracting a doppler pattern from the signal information to estimate, for a time period in which the human is determined to be exercising, exercise information including a burned calories and a number of repetitions of a movement, and outputting the exercise information.

In some embodiments, the determining comprises establishing a wireless link between the first device and the second device, measuring a signal strength of an RF signal transmitted by the second device, comparing the signal strength with a threshold value, and determining that the first device operates in the mode when the signal strength is larger than the threshold.

In some embodiments, the determining comprises establishing a wireless link between the first device and the second device, determining a round-trip time (RTT) value of an RF signal transmitted by the first device, comparing the RTT with a threshold value, and determining that the first device operates in the mode when the RTT is less than the threshold value.

In some embodiments, the determining comprises determining an energy of an audio signal transmitted by the second device, comparing the energy of the audio signal with a threshold, and determining that the first device operates in the mode when the energy of the audio signal is greater than the threshold value.

In some embodiments, the determining comprises determining that the second device is being charged by the first device, and determining that the first device operates in the mode when the second device is being charged by the first device.

In some embodiments, the determining comprises determining whether the first device and the second device are being charged by a charging device, and determining that the first device operates in the mode when the first device and the second device are being charged by the charging device.

In some embodiments, the method further comprises converting the RF signals between the first device and the second device to channel impulse response (CIR), determining that a human is within a threshold distance based on the CIR, and displaying information associated with a battery level of the first device when the human is within the threshold distance.

In some embodiments, the method further comprises determining, using a camera on the first device, an identity of the human using a face recognition process, and displaying information based on the identity of the human.

One aspect of the present disclosure provides a first device in a wireless network, the first device comprising a memory and a processor coupled to the memory. The processor is configured to determine, by the first device, whether the first device operates in a mode in which the first device and a second device coordinate to simultaneously transmit and receive radio frequency (RF) signals and the first device is within a distance of the second device. The processor is configured to exchange, by the first device, RF signals with the second device. The processor is configured to obtain, by communicating with the second device, signal information from the exchanged RF signals. The processor is configured to perform sensing based on the signal information.

In some embodiments, the processor is further configured to perform sensing by: detecting motion and breathing rate of a human from the signal information, and estimating a sleep status based on the detected motion and breathing rate of the human.

In some embodiments, the processor is further configured to perform sensing by: detecting motion of a human indicative of exercising from the signal information, extracting a doppler pattern from the signal information to estimate, for a time period in which the human is determined to be exercising, exercise information including a burned calories and a number of repetitions of a movement, and outputting the exercise information.

In some embodiments, the processor is further configured to determine whether the first device operates in the mode by establishing a wireless link between the first device and the second device, measuring a signal strength of an RF signal transmitted by the second device, comparing the signal strength with a threshold value, and determining that the first device operates in the mode when the signal strength is larger than the threshold.

In some embodiments, the processor is further configured to determine whether the first device operates in the mode by establishing a wireless link between the first device and the second device, determining a round-trip time (RTT) value of an RF signal transmitted by the first device, comparing the RTT with a threshold value, and determining that the first device operates in the mode when the RTT is less than the threshold value.

In some embodiments, the processor is further configured to determine whether the first device operates in the mode by: determining an energy of an audio signal transmitted by the second device, comparing the energy of the audio signal with a threshold, and determining that the first device operates in the mode when the energy of the audio signal is greater than the threshold value.

In some embodiments, the processor is further configured to determine whether the first device operates in the mode by determining that the second device is being charged by the first device, and determining that the first device operates in the mode when the second device is being charged by the first device.

In some embodiments, the processor is further configured to determine whether the first device operates in the mode by determining the first device and the second device are being charged by a charging device, and determining that the first device operates in the mode when the first device and the second device are being charged by the charging device.

In some embodiments, the processor is further configured to convert the RF signals between the first device and the second device to channel impulse response (CIR), determine that a human is within a threshold distance based on the CIR, and display information associated with a battery level of the first device when the human is within the threshold distance.

In some embodiments, the processor is further configured to determine, using a camera on the first device, an identity of the human using a face recognition process, and display information based on the identity of the human.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates a flow chart of an example process of using pseudo-monostatic mode of RF devices to determine sleep status in accordance with an embodiment.

FIG. 4 illustrates a flowchart of an example process of using pseudo-monostatic mode of RF devices to track exercising status in accordance with an embodiment.

FIG. 5 illustrates a flowchart of an example process of using pseudo-monostatic mode to perform proximity detection in accordance with an embodiment.

FIG. 6 illustrates a system of battery display application based on proximity detection and camera in accordance with an embodiment.

FIG. 7 illustrates a process for battery display using proximity detection based on Wi-Fi CSI in accordance with an embodiment.

FIGS. 8A, 8B and 8C illustrate a process of battery display with proximity detection and face detection in accordance with an embodiment.

FIGS. 9A, 9B and 9C illustrate a process of battery display with proximity detection only in accordance with an embodiment.

FIG. 10 illustrates proximity detection based on the statistical features of CIR in accordance with an embodiment.

FIGS. 11A, 11B, and 11C illustrate a flow chart of an example process of joint WiFi and camera motion detection with automatic gain control (AGC) compensation in accordance with an embodiment.

FIG. 12 illustrates a flowchart of an example process of determining pseudo-monostatic mode using RF signals in accordance with an embodiment.

FIG. 13 illustrates a flowchart of an example process of determining pseudo-monostatic mode using audio signals in accordance with an embodiment.

FIG. 14 illustrates a flowchart of an example process of determining pseudo-monostatic mode using charging status of one device.

FIG. 15 illustrates a flowchart of an example process of determining pseudo-monostatic mode using charging status of a charging pad in accordance with an embodiment.

FIG. 16 illustrates a flowchart of an example process of establishing signal exchange between two WiFi devices for sensing in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

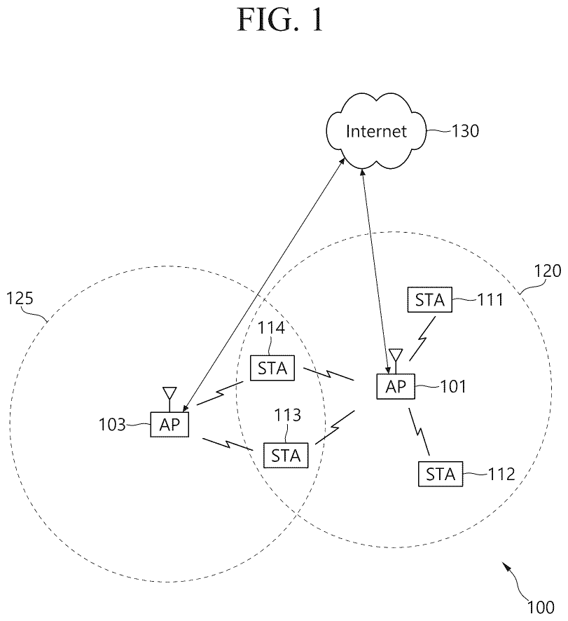

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

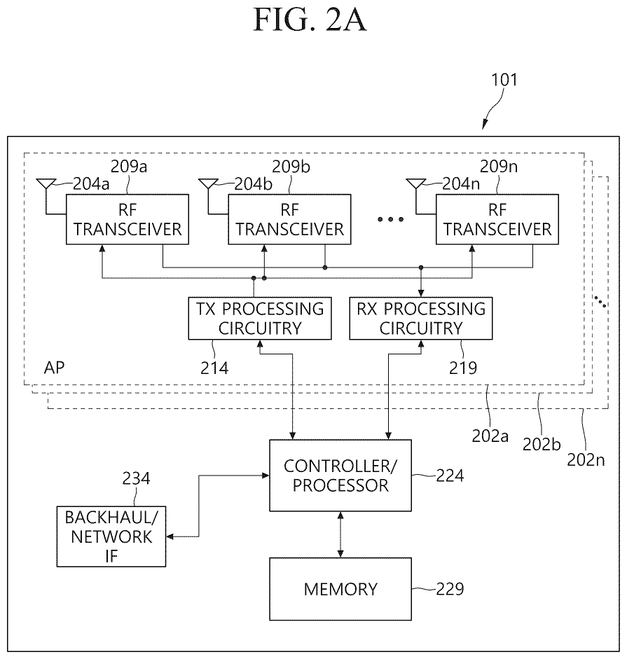

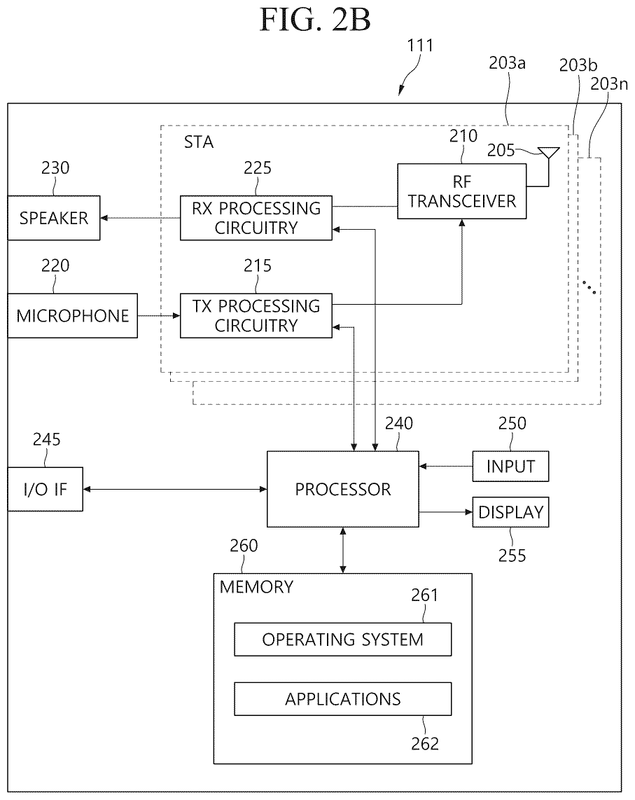

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

Embodiments in accordance with this disclosure provide for the reuse of the RF transmitter and receiver on devices to perform pseudo-monostatic sensing. For monostatic sensing, the transmitter and the receiver are usually within a single device, thus transmitter and receiver are at the same locations. For pseudo-monostatic sensing, the transmitter and receiver are usually located in two different devices, however they can cooperate to determine their relative distances and work together as a single monostatic sensor.

In some embodiments, RF modules in a device may be used to perform multi-static/bistatic sensing. Embodiments in accordance with this disclosure may use bistatic/multi-static/pseudo-monostatic RF sensing for a variety of applications, including sleep status monitoring, exercising monitoring, proximity detection, among various other applications. In particular, to reuse the available RF transmitters and receivers on current devices for sensing, one challenge is that the RF transmitter and receiver on the same device may not support duplex mode (simultaneously transmitting and receiving signals at the same time), thus making it difficult to perform monostatic (transmitter and receiver at the same location) RF sensing. However, if bistatic (transmitter and receiver at different locations) RF sensing is performed using two devices, any movements between the two devices may cause various interferences.

Embodiments in accordance with this disclosure may use a bistatic sensing setup to mimic monostatic sensing or create a pseudo-monostatic sensing. Embodiments in accordance with this disclosure may provide the pseudo-monostatic sensing that can support the duplex mode of simultaneously being able to transmit and receive RF signals at the same time. Support for the duplex mode of operation may be beneficial for a variety of sensing applications in which RF signals are being concurrently transmitted and received within an environment in order to sense the characteristics of the environment (e.g., the presence of objects/humans), where the RF signals travel at near the speed of light, and thus the ability of a device to concurrently transmit and receive signals is necessary.

Accordingly, embodiments in accordance with this disclosure may use RF signals devices to perform bistatic/multi-static sensing. Some embodiments may first determine the coverage area of the RF sensing devices based on their relative distances.

In some embodiments, a pair of RF devices may be used to perform motion and breath detection to track people's sleep status. Some embodiments may use the motion and doppler energy detection to track people's exercising status. Some embodiments may use the channel impulse response and the signal strength to perform proximity detection. Some embodiments may use individual or a combination of received signal strength indicator (RSSI), round-trip time (RTT), audio sound and/or a device's status on a charging station to determine whether devices are in close proximity to enable pseudo-monostatic mode.

Some embodiments may utilize the RF signals from different sources, including WiFi, Bluetooth, and/or ultra-wideband (UWB) devices among others to perform bi-static/multi-static sensing. For WiFi, some embodiments may use Soft AP, WiFi aware, tunneled direct link setup (TDLS), WiFi direct among others to establish communication between devices for sensing. In some embodiments, for Bluetooth, a specific signal pattern may be sent to enable multi-static sensing. In some embodiments, for UWB, device-to-device mode may be used to enable multi-static sensing.

Some embodiments may enable pseudo-monostatic sensing with multiple devices for sleep monitoring, exercising monitoring and/or proximity detection among other applications. In some embodiments, for sleep monitoring, the RF signals may be used between a pair of RF devices to detect the motion and breathing rate of human for sleep status estimation.

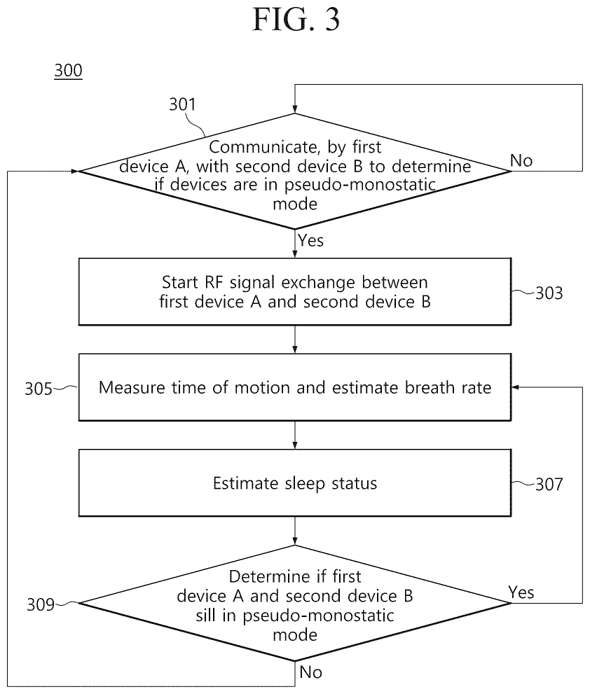

FIG. 3 illustrates a flow chart of an example process of using pseudo-monostatic mode of RF devices to determine sleep status in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 3 illustrates operations performed by a device, such as the device illustrated in FIG. 1.

The process 300, in operation 301, communicates, by a first device A with a second device B, to determine if the first device A and the second device B are in pseudo-monostatic mode. If in operation 301, the process determines that the first device A and second device B are not in pseudo-monostatic mode, the process repeats operation 301. If in operation 301, the process determines the first device A and the second device B are in pseudo-monostatic mode, then in operation 303, the process starts RF signal exchange between the first device A and the second device B. In operation 305, the process measures the time of motion and estimates a breath rate. In operation 307, the process estimates a sleep status. In operation 309, the process determines if the first device A and the second device B are still in the pseudo-monostatic mode. If the process determines in operation 309 that the first device A and the second device B are still in pseudo-monostatic mode, the process returns to operation 305, otherwise the process returns to operation 301.

In some embodiments, for exercise monitoring, the RF signals may be used between a pair of RF devices to detect motions, then the doppler pattern from the signal is extracted to estimate the burned calories and the number of repetitions of certain motions during exercising.

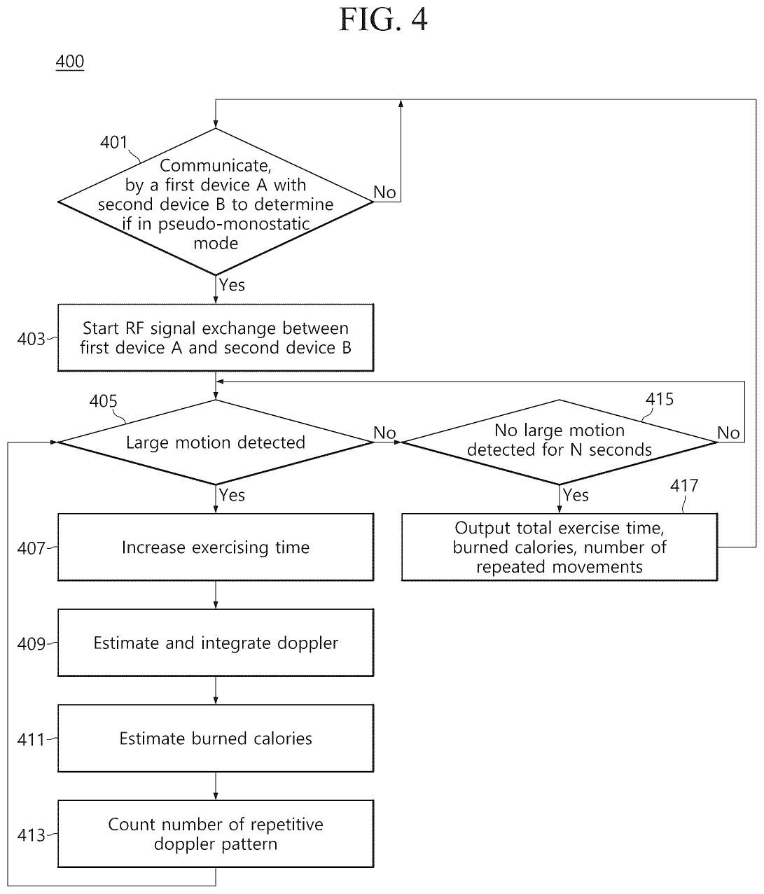

FIG. 4 illustrates a flowchart of an example process of using pseudo-monostatic mode of RF devices to track exercising status in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 4 illustrates operations performed by a device, such as the device illustrated in FIG. 1.

The process 401, in operation 401, communicates, by a first device A with a second device B, to determine if the first device A and second device B are in pseudo-monostatic mode. If in operation 401, the process determines that the first device A and the second device B are not in pseudo-monostatic mode, the process repeats operation 401. If in operation 401, the process determines that the first device A and the second device B are in pseudo-monostatic mode, the process proceeds to operation 403, where the process starts RF signal exchange between the first device A and the second device B. The process in operation 405 determines if large motion is detected. In some embodiments, the large motion is detected when the variance of the signal is larger than a certain threshold.

If in operation 405, the process determines that large motion is not detected, the process proceeds to operation 415 where the process determines whether no large motion is detected for N seconds. If in operation 415, the process determines that condition for that no large motion is detected for N seconds is not satisfied, the process returns to operation 405. If in operation 415, the process determines that condition that no large motion is detected for N seconds is satisfied, the process proceeds to operation 417 to output the total exercise time, burned calories, and/or number of repeated movements, among others and returns to operation 401.

If in operation 405, the process determines that a large motion is detected, the process proceeds to operation 407 where the process increases exercising time. In operation 409, the process estimates and integrates the doppler. In operation 411, the process estimates burned calories. In operation 413, the process counts the number of repetitive doppler patterns and returns to operation 405. In some embodiments, the repetitive doppler patterns can be used to provide a count of the particular exercise being performed (e.g., number of pushups, pullups, etc.).

In some embodiments, for proximity detection, the RF signals between two RF devices may be converted to channel impulse response (CIR). The first N taps of the CIR may be examined to check if there are motions. The N taps may be used to determine a range of distances. If motions within first N taps are detected, then the camera may be activated to determine whether a human is in close proximity. If a human is confirmed to be in close proximity, then information may be displayed on a device screen.

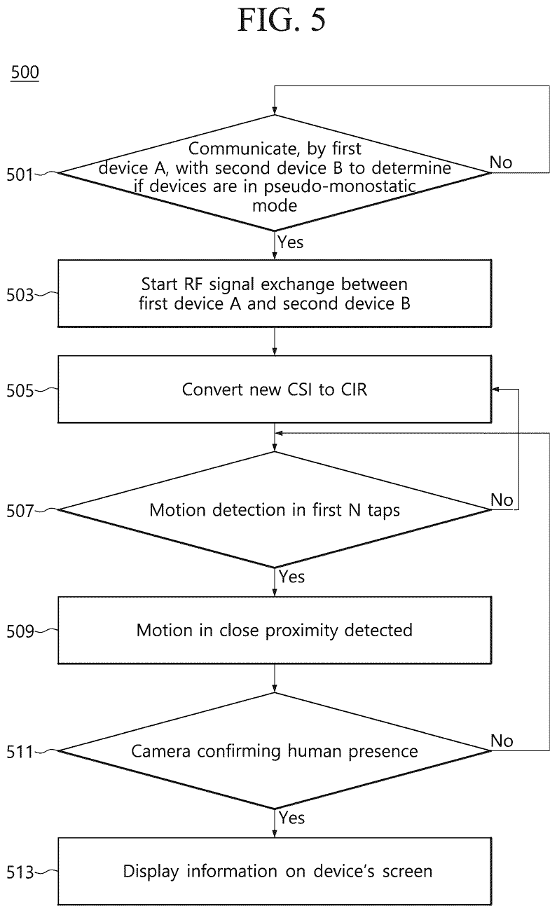

FIG. 5 illustrates a flowchart of an example process of using pseudo-monostatic mode to perform proximity detection in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 5 illustrates operations performed by a device, such as the device illustrated in FIG. 1.

The process 500 in operation 501, communicates, by a first device A with a second device B, to determine if the first device A and the second device B are in pseudo-monostatic mode. If in operation 401, the process determines that the first device A and the second device B are not in pseudo-monostatic mode, the process repeats operation 501. If in operation 501, the process determines that the first device A and the second device B are in pseudo-monostatic mode, the process proceeds to operation 503, where the process starts RF signal exchange between the first device A and the second device B. In operation 505, the process converts the new CSI to CIR. In operation 507, the process determines whether there is motion detection in the first N taps. If in operation 507, there is no motion detection in the first N taps, the process returns to operation 505. If in operation 507, the process determines there is motion detection in the first N taps, the process proceeds to operation 509 where the process sets that motion in close proximity is detected. In operation 511, the process determines whether the camera confirms human presence. If in operation 511, the camera does not confirm human presence, the process returns to operation 507. If in operation 511, the camera confirms human presence, the process proceeds to operation 514 to display information on the device's screen. Described herein are systems of battery display application based on wireless proximity detection in accordance with various embodiments.

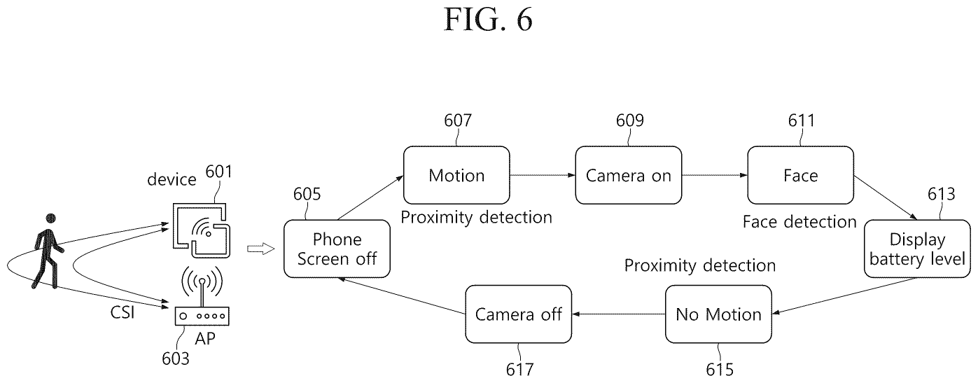

FIG. 6 illustrates a system of battery display application based on proximity detection and camera in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 6 illustrates operations performed by a device, such as the device illustrated in FIG. 1.

As illustrated in FIG. 6, a device 601 (e.g., phone) is near to the Wi-Fi AP 603, such as a wireless charging hub. The device 601 may do proximity detection using received CSI packages from the Wi-Fi AP 603. If detecting a motion 607 approaching the phone and Wi-Fi AP, the device may turn on the phone camera 609 and execute face recognition 611. In some embodiments, the face recognition 611 may use a machine learning techniques from various machine learning techniques such as multi-layer perception, convolutional neural networks. When it detects a user's face, it will display 613 the battery status, messages, and/or among other information on the screen for several seconds (e.g. 5 seconds). Then the device may not turn off the camera 617 and screen 605 until no motion 615 detection within several seconds (e.g. 10 seconds). If there is no motion for several seconds, then the device may turn the camera off 617 and the screen off 605. In some embodiments, a system of battery display application can be implemented using proximity detection based on Wi-Fi CSI only.

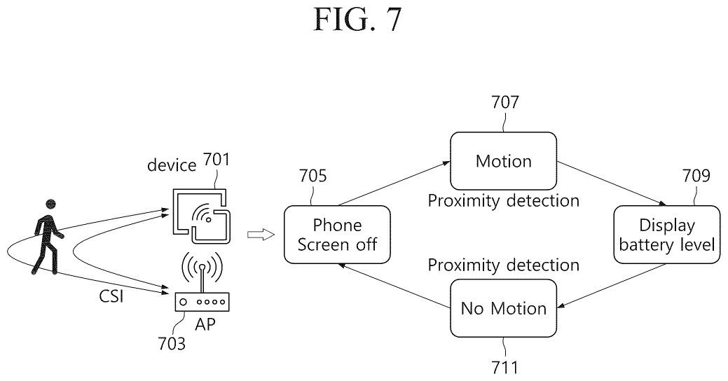

FIG. 7 illustrates a process for battery display using proximity detection based on Wi-Fi CSI in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 7 illustrates operations performed by a device, such as the device illustrated in FIG. 1.

As illustrated, a device 701 may be close to an AP 701. When the device 701 detects proximity 707, it may display the battery status 709 on its screen. In some embodiments, the proximity may be determined using Wi-Fi CSI based proximity detection. Then the phone won't turn off the screen until no proximity is detected within a pre-set duration (e.g. 10 seconds). As illustrated, there is no motion 711 for a set duration, then the phone screen is turned off 705.

In some embodiments, a device (e.g., phone) may receive CSI packages from the Wi-Fi AP and may store data into a CSI Buffer with length N (e.g. 300). In some embodiments, the device may then calculate STD of every subcarrier using the latest CSI data within a T₁ (e.g. 1.5 seconds) seconds sliding window and a longer timer T₂ (e.g. 5 seconds), separately. The median STD ml_{std} in a shorter time sliding window is used to detect a large motion.

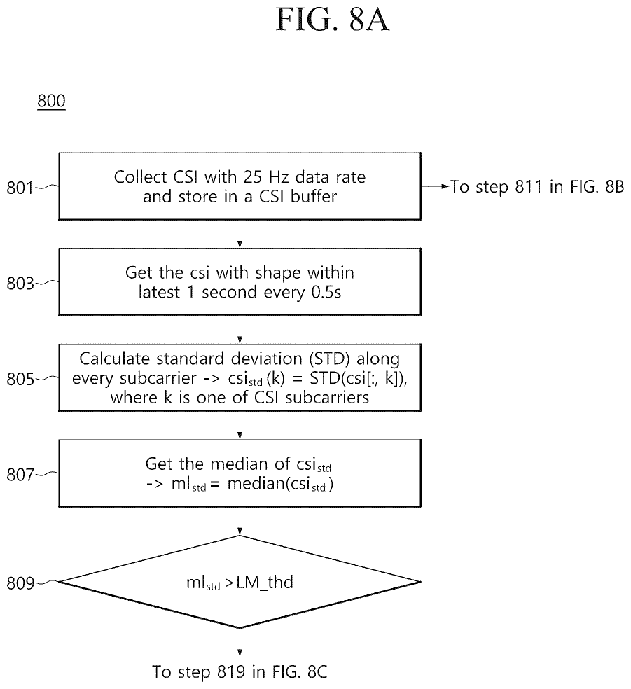

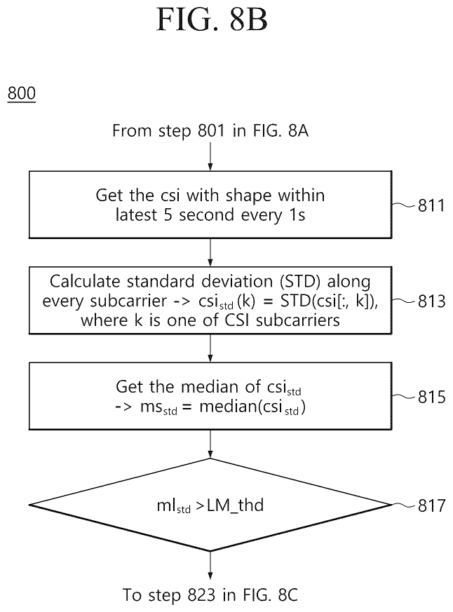

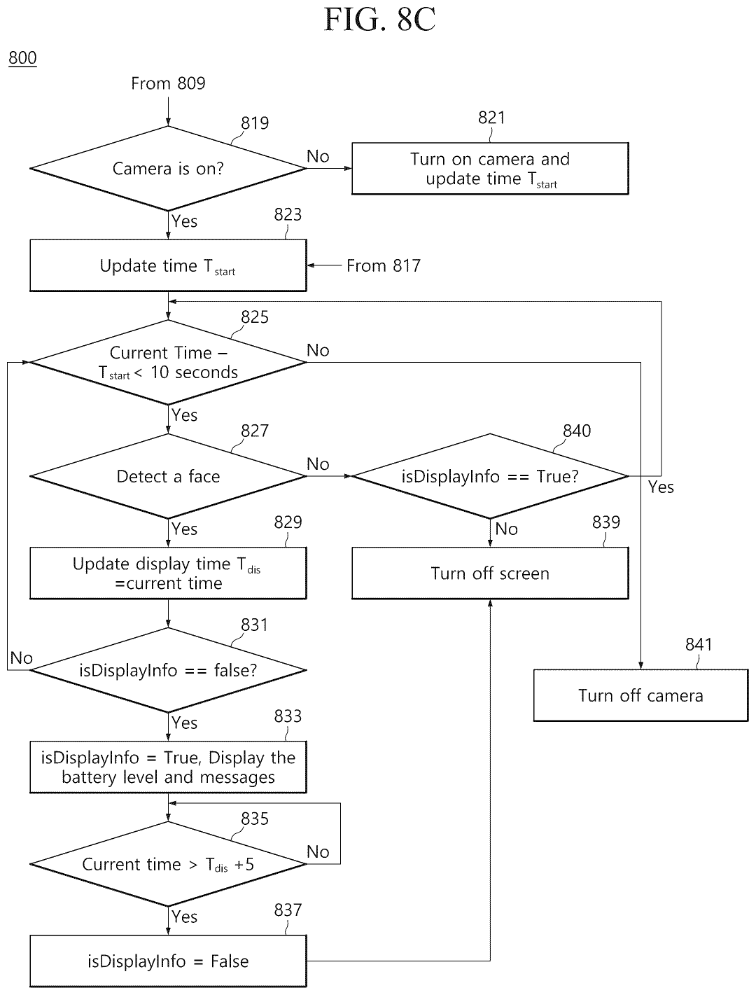

FIGS. 8A, 8B and 8C illustrate a process of battery display with proximity detection and face detection in accordance with an embodiment. Although one or more operations are described or shown in a particular sequential order, in other embodiments the operations may be rearranged in a different order, which may include performance of multiple operations in at least partially overlapping time periods. The flowchart depicted in FIGS. 8A, 8B and 8C illustrates operations performed by a device, such as the device illustrated in FIG. 1.

The process 800, in operation 801, collects CSI with 25 Hz data rate and stores the CSI in a CSI buffer. The process may concurrently perform operations 803-809 and 811-817. In operation 803, the process gets the csi with shape within the latest 1 second every 0.5 s.

In operation 805, the process calculates standard deviation (STD) along every subcarrier: csi_{std}(k)=STD (csi [:, k]) where k is one of CSI subcarriers.

In operation 807, the process gets the median of csi_{std}: ml_{std}=median (csi_{std}).

In operation 809, the process determines whether ml_{std}>LM_thd. If in operation 809, the condition ml_{std}>LM_thd is satisfied, the process proceeds to operation 819 illustrated in FIG. 8C.

Referring back to operation 801, the process may also proceed to operation 811 in FIG. 8C to get the csi with shape within latest 5 second every 1 s. In operation 813, the process calculates standard deviaction (STD) along every subcarrier: csi_{std} (k)=STD (csi [:, k]) where k is one of CSI subcarriers.

In operation 815, the process gets the median of csi_{std}: ms_{std}=median (csi_{std}).

In operation 817, the process determines whether the median is greater than a threshold, ms_{std}>SM_thd.

In operation 817, if the condition ms_{std}>SM_thd is satisfied, the process proceeds to operation 823 in FIG. 8C.

Referring to FIG. 8C, the output from operation 809 in FIG. 8A is provided to operation 819, where the process determines whether the camera is on. If in operation 819, the process determines that the camera is not on, the process proceeds to operation 821 where the process turns on the camera and updates time Tₛₜₐᵣₜ.

If in operation 819, the process determines that the camera is on, the process proceeds to operation 823 to update time Tₛₜₐᵣₜ.

Then in operation 825, the process determines the condition current-time minus Tₛₜₐᵣₜ<10 seconds.

If in operation 825, the process determines that the condition current time minus Tₛₜₐᵣₜ<10 seconds is not satisfied, the process proceeds to operation 841 to turn off the camera.

If in operation 825, the process determines that the condition current time minus Tₛₜₐᵣₜ<10 seconds is satisfied, then in operation 827, the process determines whether it detects a face.

If in operation 827, the process determines that it does not detect a face, the process proceeds to operation 840 where it determines if isDisplayinfo==true (determine whether the information is being displayed). If the condition isDisplayinfo==true is satisfied (the information is being displayed), the process returns to operation 825. If the condition isDisplayInfo==true is not satisfied (the information is not being displayed), the process proceeds to operation 839 to turn off the screen.

Returning to operation 827, if the condition detects a face is satisfied, the process proceeds to operation 829 where the process updates the display time T_{dis}=current time. Then in operation 831, the process determines whether the condition isDisplayinfo==false (whether the information is not being displayed). In operation 831, if the condition isDisplayinfo==false is not satisfied (the information is being displayed), the process returns to operation 823. If in operation 831, the condition isDisplayinfo==false is satisfied (the information is not being displayed), the process proceeds to operation 833 where isDisplayinfo=true (the variable isDispalyinfo is set to true) and displays the battery level and messages. Then in operation 835, the process determines the condition Current time>T_{dis}+5. If in operation 835, the condition current time>T_{dis}+5 is not satisfied, the process repeats operation 835. If in operation 835, the condition current time>T_{dis}+5 is satisfied, then in operation 837, the process sets isDisplayinfo=false (sets the variable isDisplayinfo to false). In operation 839, the process turns off the screen and returns to operation 825.

In operation 809 of FIG. 8A, when ml_{std} is larger than the threshold LM_thd, the phone will turn on screen and the front camera. And the process of face detection is also activated. There is a timer tₛₜₐᵣₜ to control the camera. In operation 825, if time difference in system time and tₛₜₐᵣₜ is more then a number of seconds (e.g., 10 seconds), the camera will be turned off 841. The median STD ms_{std} in a longer time sliding window is used to detect small motion and update the tₛₜₐᵣₜ to keep the camera on. In operation 827, if a user's face is detected, the phone displays the battery status on the screen for a period of time (e.g., 5 seconds) and then turns off the screen.

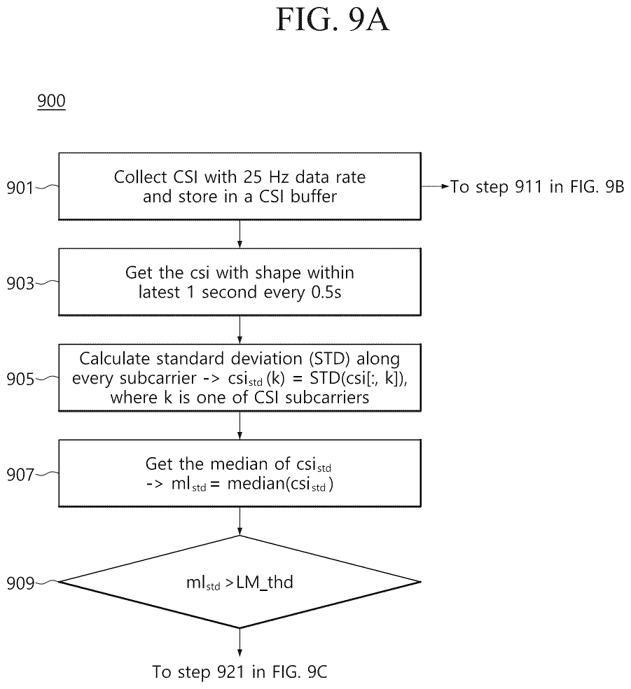

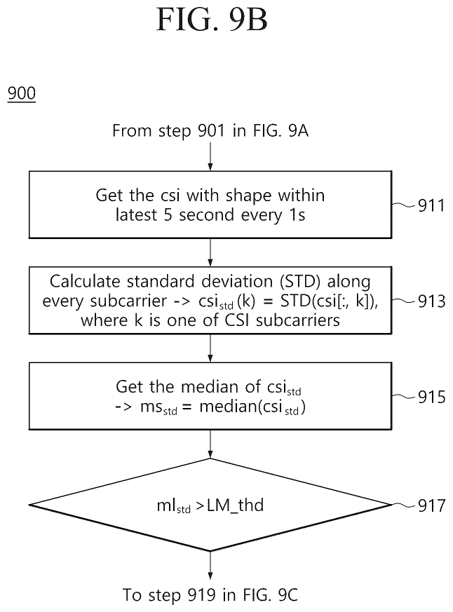

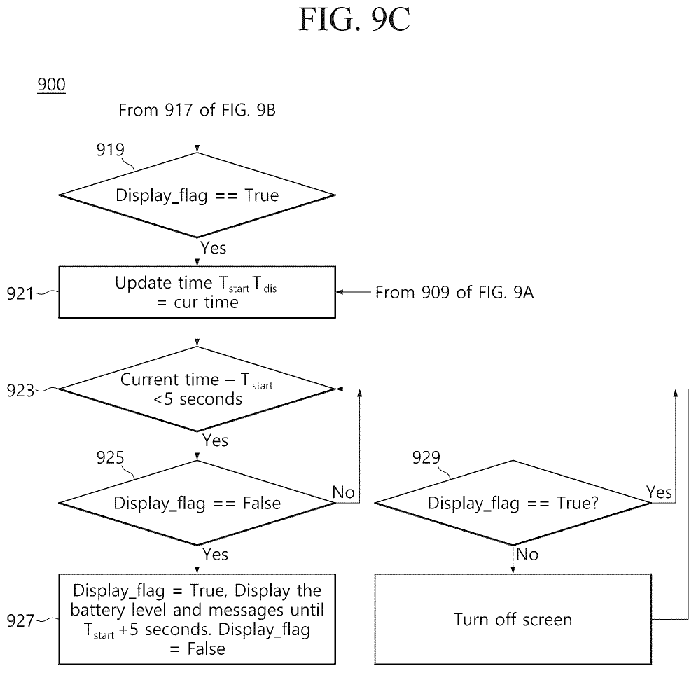

FIGS. 9A, 9B and 9C illustrate a process of battery display with proximity detection only in accordance with an embodiment. Although one or more operations are described or shown in a particular sequential order, in other embodiments the operations may be rearranged in a different order, which may include performance of multiple operations in at least partially overlapping time periods. The flowchart depicted in FIGS. 9A, 9B and 9C illustrates operations performed by a device, such as the device illustrated in FIG. 1.

The process, in operation 901, the process collects CSI with 25 Hz data rate and stores the CSI in a CSI buffer. The process may concurrently perform operations 903-909 and 911-917. In operation 903, the process gets the csi with shape within the latest 1 second every 0.5 s.

In operation 905, the process calculates standard deviation (STD) along every subcarrier: csi_{std} (k)=STD (csi [:, k]) where k is one of CSI subcarriers.

In operation 907, the process gets the median of csi_{std}: ml_{std}=median (csi_{std}).

In operation 909, the process determines whether ml_{std}>LM_thd. If in operation 909, the condition ml_{std}>LM_thd is satisfied, the process proceeds to operation 921 in FIG. 9C.

In operation 911 of FIG. 9B, the process gets the csi with shape within latest 5 second every 1 s. In operation 913, the process calculates standard deviation (STD) along every subcarrier: cSi_{std}(k)=STD (csi [:, k]) where k is one of CSI subcarriers.

In operation 915, the process gets the median of csi_{std}: ms_{std}=median (csi_{std}).

In operation 917, the process determines the condition ms_{std}>SM_thd.

In operation 917, if the condition ms_{std}>SM_thd is satisfied, the process proceeds to operation 919 of FIG. 9C.

In operation 919 of FIG. 9C, the process determines the condition Display_flag==true? (the information is being displayed). If in operation 919, the process determines the condition Display_flag==true is satisfied (the information is being displayed), then the process proceeds to operation 921 where the process updates time Tₛₜₐᵣₜ T_{dis}=cur time. Then in operation 923, the process determines the condition current time−Tₛₜₐᵣₜ<5 seconds. If in operation 923, the condition current time−Tₛₜₐᵣₜ<5 seconds is satisfied, then in operation 925, the process determines whether the condition Display_flag==false? (the information is not being displayed). If in operation 925, the process determines the condition Display_flag==false is not satisfied (the information is being displayed), the process returns to operation 923.

If in operation 925, the process determines the condition Display_flag==false is satisfied (the information is not being displayed), the process proceeds to operation 927 where display_flag=True (variable display_flag is set to true) and displays the battery level and messages until T_{dis}+5 seconds, then display_flag=False (variable display_flag is set to False).

In operation 929, if the condition Display_flag==true is satisfied (the information is being displayed), the process returns to operation 923.

In operation 929, if the condition Display_flag==True is not satisfied (the information is not being displayed), the process proceeds to operation 931 to turn off the screen, then returns to operation 923.

In FIGS. 9A-9C, when ml_{std} is larger than the threshold LM_thd, the phone will turn on screen only and initialize a timer tₛₜₐᵣₜ to turn screen and a time t_{dis} to display battery status. The median STD ms_{std} in a longer time sliding window is used to detect small motion and update the tₛₜₐᵣₜ and t_{dis} to keep the screen on and display the battery status.

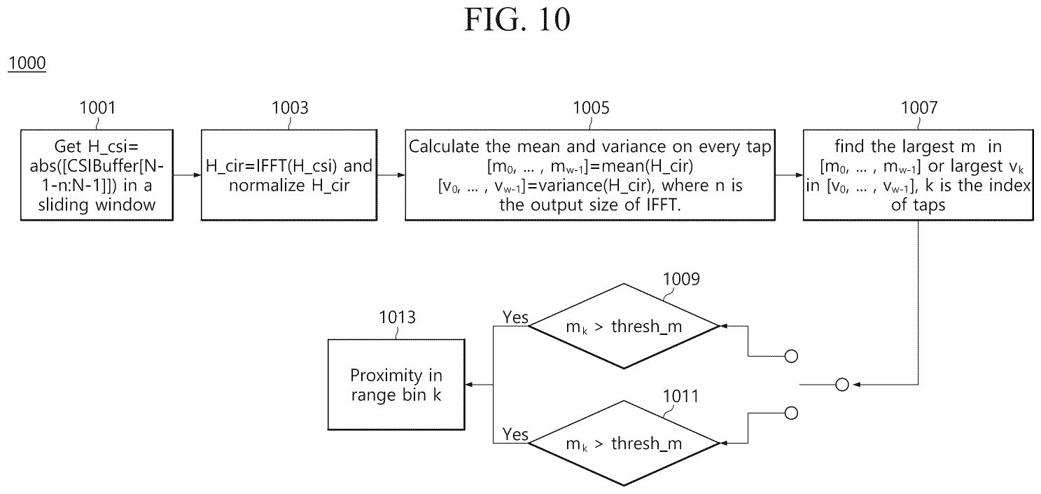

FIG. 10 show proximity detection based on the statistical features of CIR. Although one or more operations are described or shown in a particular sequential order, in other embodiments the operations may be rearranged in a different order, which may include performance of multiple operations in at least partially overlapping time periods. The flowchart depicted in FIG. 10 illustrates operations performed by a device, such as the device illustrated in FIG. 1.

In operation 1001, if the device only receives CSI data from a Wi-Fi AP, CIR can be calculated in operation 1003 using IFFT and do normalization for every CIR as below.

$${H}_{cir [ i , j ]} = \frac{{H}_{cir [ i , j ]}}{{\sum }_{m = 0}^{m = w - 1} {H}_{cir [ i , m ]}}$$

Where w is the output size of IFFT, j∈n, and i is an index in the H_cir. Then in operation 1005, the process calculates the mean and variance on every tap and in operation 1007 the process finds the largest mean m or largest variance vₖ, where k is an index of taps. In operation 1009 if mₖ>thresh_m or in operation 1011 vₖ>thresh_v, the process predicts in operation 1013 proximity at rang bin k. Although the distance of range bin is meter level (e.g. 1.8 m between 2 range bins with Wi-Fi bandwidth 80 Mhz), proximity detection based on CIR still can apply for battery status display in a charging phone.

For proximity detection, some embodiments may use a CSI energy-based method for detection. Some embodiments may use statistics of the average CSI power per packet to determine if there are large motions near the pseudo-monostatic WiFi devices. However, due to WiFi receiver automatic gain control (AGC), the unwanted wifi packet energy fluctuation due to AGC compensation can be observed. To compensate for AGC, some embodiments may collect several Wi-Fi packets and divide them into several clusters by running DBSCAN (Density-based spatial clustering of applications with noise) algorithm on the CSI packet energy. For the csi packets in each cluster, some embodiments may divide each CSI packet's energy by the mean of the CSI energy cluster. After the clusters are created, for each new WiFi packet, some embodiments may directly check which cluster it belongs to and may normalize the packet's CSI energy with that clusters' mean value.

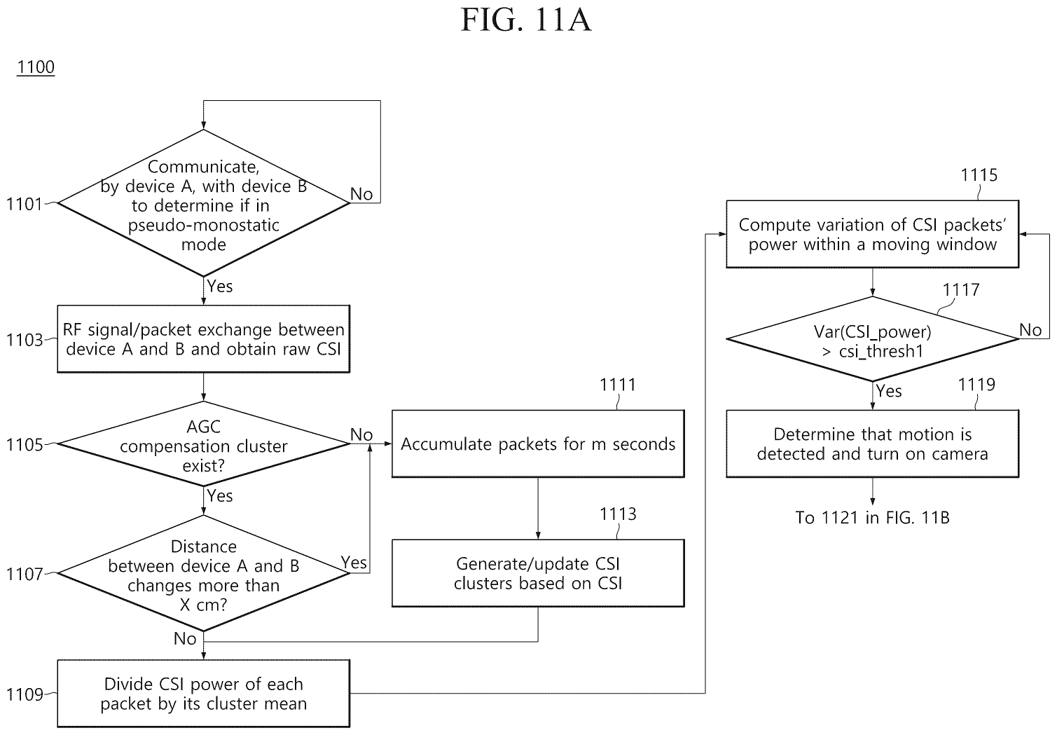

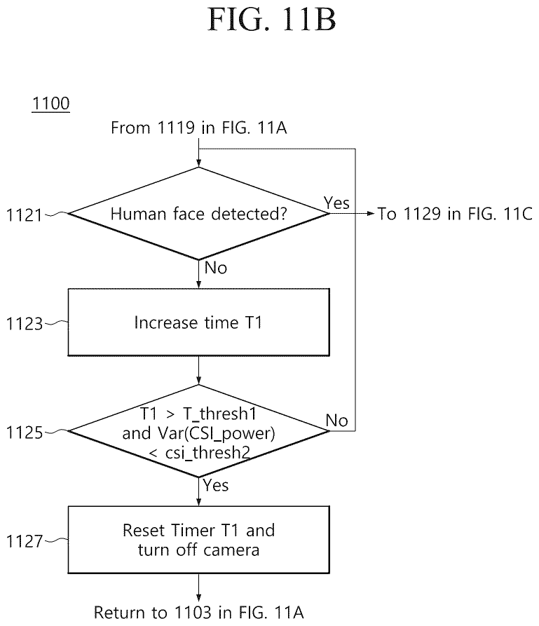

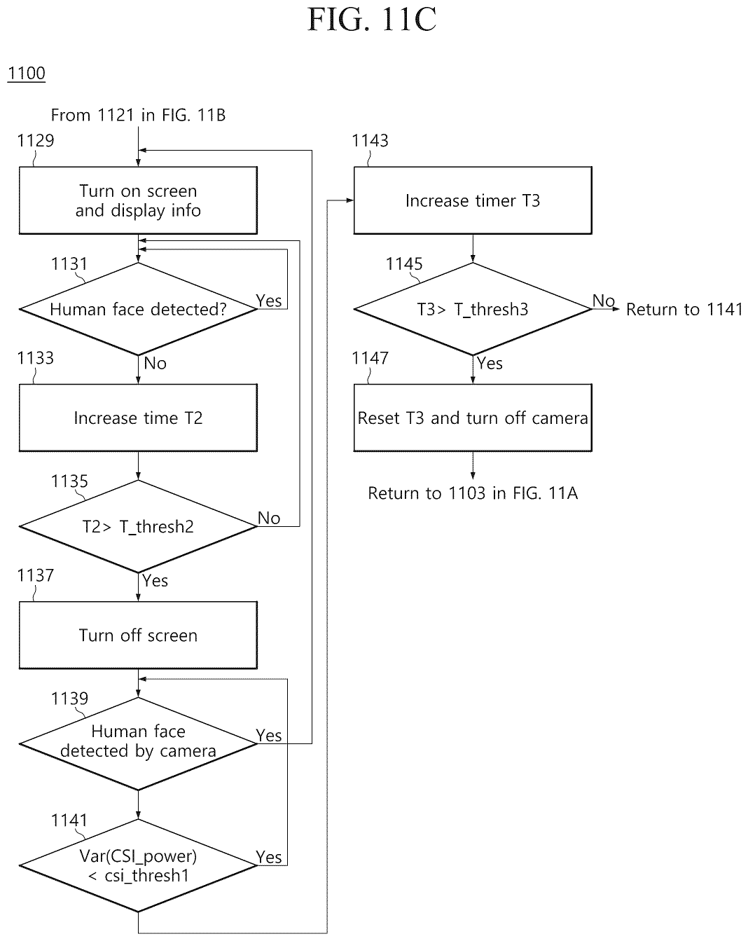

FIGS. 11A, 11B, and 11C illustrates a flow chart of an example process of joint wifi and camera motion detection with AGC compensation in accordance with an embodiment. Although one or more operations are described or shown in a particular sequential order, in other embodiments the operations may be rearranged in a different order, which may include performance of multiple operations in at least partially overlapping time periods. The flowchart depicted in FIGS. 11A, 11B and 11C illustrate operations performed by a device, such as the device illustrated in FIG. 1.

The process, in operation 1101, communicates, by a first device A, with a second service B to determine if the devices are in pseudo-monostatic mode. If in operation 1101, the process determines that the devices are not in pseudo-monostatic mode, the process repeats operation 1101. If in operation 1101, the process determines that at the devices are in pseudo-monostatic mode, the process proceeds to operation 1103 where the devices exchange RF signals/packets and obtain raw CSI data. In operation 1105, the process determines the condition whether an AGC compensation cluster exists. If in operation 1105, the process determines the condition that the AGC compensation cluster exists is not satisfied, the process proceeds to operation 1101 to accumulate packets for M seconds. Then the process proceeds to operation 1114 to generate/update CSI clusters based on the CSI and proceeds to operation 1109.

In operation 1105, if the process determines the condition whether AGS compensation cluster exists is satisfied, the process proceeds to operation 1107. In operation 1107, the process determines the condition whether the distance between device A and device B changes more than an amount of X cm? If in operation 1107, the process determines that the condition that device A and device B changes more than the amount of X cm is satisfied, the process proceeds to operation 1107 and performs the operations as already described.

If in operation 1107, the process determines that the condition that device A and device B changes more than X cm is not satisfied, the process proceeds to operation 1109. In operation 1109, the process divides the CSI power of each packet by its cluster mean. In operation 1115, the process computes the variation of CSI packets' power within a moving window. In operation 1117, the process determines the condition whether the variance of the CSI power is greater than a first threshold (i.e., Var (CSI_power)>csi_thresh1). In operation 1117, if the condition that the variance of the CSI power is greater than the first threshold is not satisfied, the process returns to operation 1115. If in operation 1117, the condition that the variance of the CSI power is greater than the first threshold is satisfied, the process proceeds to operation 1119. In operation 1119, the process determines that motion is detected and turns on the camera. The process proceeds to operation 1121 in FIG. 11B.

In FIG. 11B, in operation 1121, the process determines the condition whether a human face is detected. If in operation 1121, the process determines that the condition regarding whether a human face is detected is satisfied, the process proceeds to operation 1129 of FIG. 11C. If in operation 1121, the process determines that a human face is not detected, the process proceeds to operation 1123. In operation 1123, the process increases a time T1. In operation 1125, the process determines whether the condition that T1 is greater than a first threshold and the variance of the CSI power is less than a second threshold (i.e., T1>T_thresh1 and Var (CSI_power)<csi_thresh2). If the condition that T1 is greater than a first threshold and the variance of the CSI power is less than a second threshold is not satisfied, the process returns to operation 1121. If the condition that T1 is greater than a first threshold and the variance of the CSI power is less than a second threshold is satisfied, the process proceeds to operation 1127. In operation 1127, the process resets the timer T1 and turns off the camera. The process proceeds returns to operation 1103 in FIG. 11A.

In FIG. 11C, operation 1129 receives an input the output from operation 1121 in FIG. 11B. In operation 1129, the process turns on the screen and displays information. In operation 1131, the process determines the condition whether a human face is detected. If in operation 1131, the process determines that a human face is detected, the process returns to operation 1131. If in operation 1131, the process determines that a human face is not detected, the process proceeds to operation 1131. In operation 1133, the process increases a time T2. In operation 1135, the process determines the condition whether T2 is greater than a second threshold (i.e., T2>T_thresh2). If in operation 1135, the process determines the condition that T2 is greater than the second threshold is not satisfied, the process returns to operation 1131. If in operation 1135 the process determines the condition that T2 is greater than the second threshold is satisfied, the process proceeds to operation 1137. In operation 1137, the process turns off the screen. In operation 1139, the process determines whether a human face is detected by the camera. If in operation 1139, the process determines that the human face is detected by the camera, the process returns to operation 1129. If in operation 1139, the process determines that the condition whether a human face is detected by the camera is not satisfied, the process proceeds to operation 1141. In operation 1141, the process determines the condition whether the variance of the CSI power is less than a first threshold (i.e., Var (CSI_power)<csi_thresh1). If in operation 1141, the process determines that the condition that the variance of the CSI power is less than a first threshold is satisfied, the process returns to operation 1139. If in operation 1141, the process determines that the condition that the variance of the CSI power is less than a first threshold is not satisfied, the process proceeds to operation 1143. In operation 1143, the process increases a timer T3. In operation 1145, the process determines the condition whether the time T3 is greater than a third threshold (i.e., T3>T_threshd3). If in operation 1145, the process determines that the condition T3 is greater than the third threshold is not satisfied, the process returns to operation 1141. If in operation 1145, the process determines that the condition T3 is greater than the third threshold is satisfied, the process proceeds to operation 1147. In operation 1147, the process resets the timer T3 and turns off the camera. The process then returns to operation 1103 in FIG. 11A.

Hereinafter, methods for detecting pseudo-monostatic/multi-static status of RF sensors for sensing in accordance with several embodiments are described.

Some embodiments may detect/determine whether the current scenario is suitable to enable the pseudo-monostatic/multi-static RF sensing mode. To detect whether the RF transmitting and receiving devices are close together, the transmitters RSSI, RTT value measured by the receiver can be used. The exemplary RF transmitting and receiving devices can be phones, wireless earbuds, tablet, smart watches,

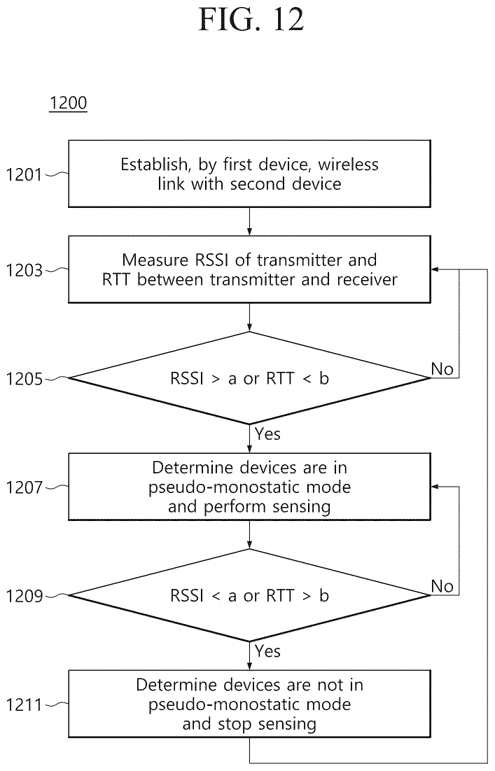

FIG. 12 illustrates a flowchart of an example process of determining pseudo-monostatic mode using RF signals in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 12 illustrates operations performed by a device, such as a device illustrated in FIG. 1.

The process 1200, in operation 1201, establishes by a first device, a wireless link with a second device. In operation 1203, the process measures RSSI of transmitter and RTT between transmitter and receiver based on communications between the devices.

In some embodiments, the RSSI is the measured received packet signal strength at the receiver. In some embodiments, the typical range of threshold a is −10 dbm to −30 dbm. The RTT are the measured round-trip-time from transmitter to receiver and then receiver back to transmitter at the transmitter side. The typical range of threshold b is 0.1 to 2 meters.

In operation 1205, the process determines whether RSSI>a or RTT<b. If the condition RSSI>a or RTT<b in operation 1205 is not satisfied, the process returns to operation 1203. If the condition RSSI>a or RTT<b in operation 1205 is satisfied, the process proceeds to operation 1207 where the process determines that the devices are in pseudo-monostatic mode and the process performs sensing.

In operation 1209, the process determines whether RSSI<a or RTT>b. If in operation 1209, the condition RSSI<a or RTT>b is not satisfied, the process returns to operation 1207. If in operation 1209, the condition RSSI<a or RTT>b is satisfied, the process proceeds to operation 1211 where the process determines the devices are not in pseudo-monostatic mode and the process stops sending. The process returns to operation 1203. In some embodiments, an audio signal transmitted from one device and measured by another device can be used to determine the pseudo-monostatic status.

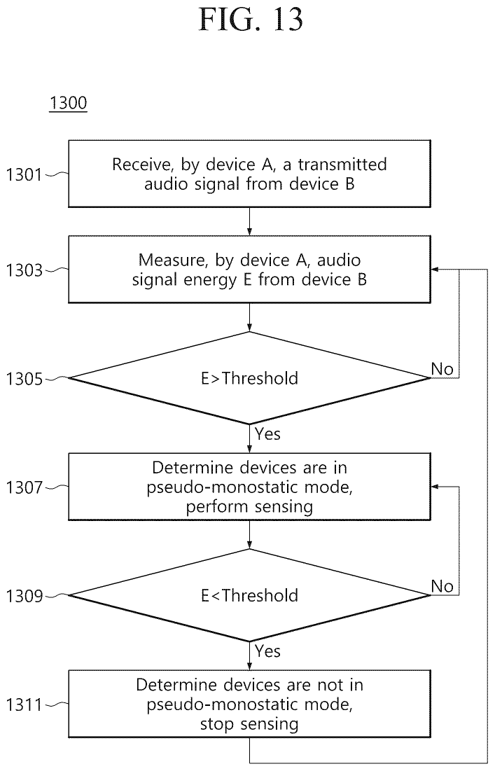

FIG. 13 illustrates a flowchart of an example process of determining pseudo-monostatic mode using audio signals in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 13 illustrates operations performed by a device, such as the device illustrated in FIG. 1.

The process 1300, in operation 1301, device A receives an audio signal that is being transmitted by device B. In operation 1303, device A measures the audio signal energy E from device B. In operation 1305, the process determines whether E>threshold. If in operation 1305, the process determines that the condition E>threshold is not satisfied, the process returns to operation 1303. If in operation 1305, the process determines that the condition E>threshold is satisfied, the process proceeds to operation 1307 where the process determines the devices are not in pseudo-monostatic mode and the process performs sensing. The process proceeds to operation 1309 where it determines whether the condition E<threshold. If in operation 1309, the condition E<threshold is not satisfied, the process returns to operation 1307. If in operation 1309, the condition E<threshold is satisfied, the process proceeds to operation 1311 where the process determines the devices are not in pseudo-monostatic mode and the process stops sensing. The process then returns to operation 1303.

In some embodiments, whether device A is providing wireless charging to device B can be used to determine pseudo-monostatic mode.

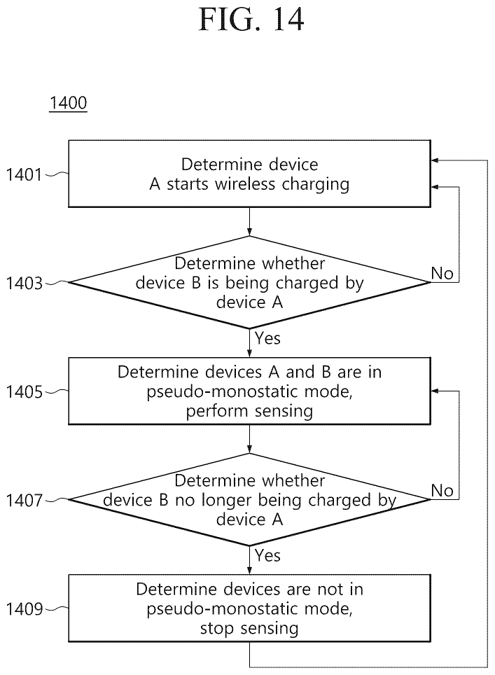

FIG. 14 illustrates a flowchart of an example process of determining pseudo-monostatic mode using charging status of one device. Although one or more operations are described or shown in a particular sequential order, in other embodiments the operations may be rearranged in a different order, which may include performance of multiple operations in at least partially overlapping time periods. The flowchart depicted in FIG. 14 illustrates operations performed by a device, such as the device illustrated in FIG. 1.

The process 1400, in operation 1401 the process determines that device A starts wireless charging. In operation 1403, the process determines the condition whether device B is being charged by device A. In operation 1403, if the condition that device B is being charged by device A is not satisfied, the process returns to operation 1401. In operation 1403, the process determines if the condition that device B is being charged by device A is satisfied, the process proceeds to operation 1405 and determines the device A and device B are in pseudo-monostatic mode and the process performs sensing. The process proceeds to operation 1407 where the process determines the condition whether device B no longer is being charged by device A. If in operation 1407, the condition that device B is no longer being charged by device A is not satisfied, the process returns to operation 1405. If in operation 1407, the condition that device B is no longer being charged by device A is satisfied, the process proceeds to operation 1409 where the process determines the devices are not in pseudo-monostatic mode and the process stops sensing. The process then returns to operation 1401. In some embodiments, whether device A and device B are being charged by the same wireless charging pad can be used to determine pseudo-monostatic status.

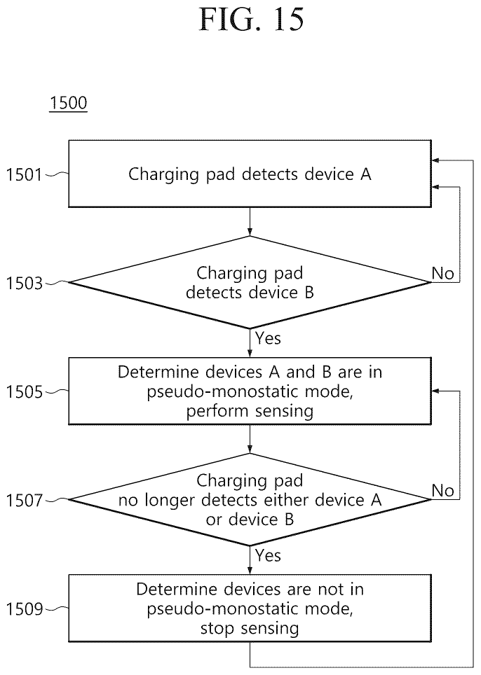

FIG. 15 illustrates a flowchart of an example process of determining pseudo-monostatic mode using charging status of a charging pad in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 3 illustrates operations performed by a device.

The process 1500, in operation 1501, the charging pad detects device A. In operation 1503, the process determines the condition whether the charging pad detects device B. If in operation 1503, the condition that the charging pad detects device B is not satisfied, the process returns to operation 1501. If in operation 1503, the condition that the charging pad detects device B is satisfied, the process proceeds to operation 1505 and determines device A and B are in pseudo-monostatic mode and the process performs sensing. In operation 1507, the process determines the condition whether charging pad no longer detects either device A or device B. If in operation 1507, the condition that the charging pad no longer detects either device A or device B is not satisfied, the process returns to operation 1505. If in operation 1507, the condition that the charging pad no longer detects either device A or device B is satisfied, the process proceeds to operation 1509 and determines the devices are not in pseudo-monostatic mode and the process stops sensing. The process then returns to operation 1501.

Hereinafter are described RF signal based multi-device sensing in accordance with several embodiments.

In some embodiments, to perform pseudo-monostatic multi-device sensing using the current available RF transceivers on devices, the RF signal used in device-to-device communication may be used for sensing purpose. In some embodiments, the RF signals from WiFi devices may be used.

In some embodiments, for WiFi based multi-device sensing device-to-device communication may be established through a P2P WiFi protocol such as but not limited to WiFi direct, WiFi aware, WiFi TDLS, WiFi softAP. After establishment of WiFi links, the devices under user-control can be used as the master device. The master device may be repeatedly sending WiFi packets to the other devices. The other devices may reply with an ACK packet (or other packet) which the master device may use to extract the channel impulse response (CIR). In some embodiments, the master device may listen to the periodic frames sent by the other devices to extract CIR info. One example of the periodic frames can be the beacon frame. The CIR info may be used for sensing.

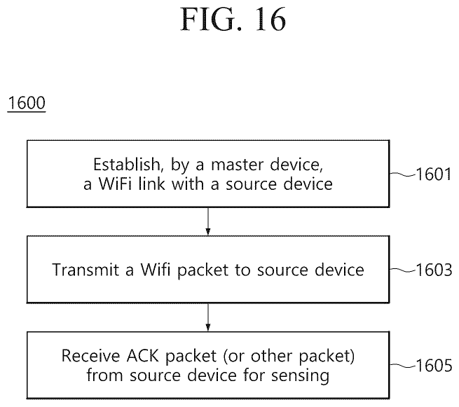

FIG. 26 illustrates a flowchart of an example process of establishing signal exchange between two WiFi devices for sensing in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 16 illustrates operations performed by a device, such as the device illustrated in FIG. 1.

The process 1600, in operation 1601 the process establishes, by a master device, a WiFi link with a source device. In operation 1603, the master device sends a WiFi packet to the source device. In operation 1605, the master device receives and uses a returned ACK packet or other packet for sensing. In some embodiments, the master device may use the ACK packet to extract the channel impulse response (CIR) for sensing.

In some embodiments, Bluetooth devices may be used. For Bluetooth, the master device can send a long sequence of 1 s followed by a long sequence of 0 s (several continuous 1 s and then several continuous 0 s). Then the CIR from all the hopped frequency bands may be stitched together to get the wideband CIR info. The steps performed on the CIR to enable sensing are described in FIG. 16 in accordance with an embodiment. In some embodiments, UWB devices may be used. For UWB, the master device can send a UWB packet to other devices and uses the ack packet to get the CIR for sensing. Or the master device can listen to the packet sent periodically by the other devices and extract the CIR for sensing. The steps performed on the CIR to enable sensing are described in FIG. 16 in accordance with an embodiment.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method for multi-device sensing at a first device in a wireless network, the method comprising:
determining, by the first device, whether the first device operates in a mode in which the first device and a second device coordinate to simultaneously transmit and receive radio frequency (RF) signals and the first device is within a distance of the second device;
exchanging, by the first device, RF signals with the second device;
obtaining, by communicating with the second device, signal information from the exchanged RF signals; and
performing sensing based on the signal information.

2. The computer-implemented method of claim 1, wherein the performing sensing comprises:
detecting motion and breathing rate of a human from the signal information; and
estimating a sleep status based on the detected motion and breathing rate of the human.

3. The computer-implemented method of claim 1, wherein the performing sensing comprises:
detecting motion of a human indicative of exercising from the signal information;
extracting a doppler pattern from the signal information to estimate, for a time period in which the human is determined to be exercising, exercise information including a burned calories and a number of repetitions of a movement; and
outputting the exercise information.

4. The computer-implemented method of claim 1, wherein the determining comprises:
establishing a wireless link between the first device and the second device;
measuring a signal strength of an RF signal transmitted by the second device;
comparing the signal strength with a threshold value; and
determining that the first device operates in the mode when the signal strength is larger than the threshold.

5. The computer-implemented method of claim 1, wherein the determining comprises:
establishing a wireless link between the first device and the second device;
determining a round-trip time (RTT) value of an RF signal transmitted by the first device;
comparing the RTT with a threshold value; and
determining that the first device operates in the mode when the RTT is less than the threshold value.

6. The computer-implemented method of claim 1, wherein the determining comprises:
determining an energy of an audio signal transmitted by the second device;
comparing the energy of the audio signal with a threshold; and
determining that the first device operates in the mode when the energy of the audio signal is greater than the threshold value.

7. The computer-implemented method of claim 1, wherein the determining comprises:
determining that the second device is being charged by the first device; and
determining that the first device operates in the mode when the second device is being charged by the first device.

8. The computer-implemented method of claim 1, wherein the determining comprises:
determining whether the first device and the second device are being charged by a charging device; and
determining that the first device operates in the mode when the first device and the second device are being charged by the charging device.

9. The computer-implemented method of claim 1, further comprising:
converting the RF signals between the first device and the second device to channel impulse response (CIR);
determining that a human is within a threshold distance based on the CIR; and
displaying information associated with a battery level of the first device when the human is within the threshold distance.

10. The computer-implemented method of claim 9, further comprising:
determining, using a camera on the first device, an identity of the human using a face recognition process; and
displaying information based on the identity of the human.

11. A first device in a wireless network, the first device comprising:
a memory;
a processor coupled to the memory, the processor configured to:
determine, by the first device, whether the first device operates in a mode in which the first device and a second device coordinate to simultaneously transmit and receive radio frequency (RF) signals and the first device is within a distance of the second device;
exchange, by the first device, RF signals with the second device;
obtain, by communicating with the second device, signal information from the exchanged RF signals; and
perform sensing based on the signal information.

12. The first device of claim 11, wherein the processor is further configured to perform sensing by:
detecting motion and breathing rate of a human from the signal information; and
estimating a sleep status based on the detected motion and breathing rate of the human.

13. The first device of claim 11, wherein the processor is further configured to perform sensing by:
detecting motion of a human indicative of exercising from the signal information;
extracting a doppler pattern from the signal information to estimate, for a time period in which the human is determined to be exercising, exercise information including a burned calories and a number of repetitions of a movement; and
outputting the exercise information.

14. The first device of claim 11, wherein the processor is further configured to determine whether the first device operates in the mode by:
establishing a wireless link between the first device and the second device;
measuring a signal strength of an RF signal transmitted by the second device;
comparing the signal strength with a threshold value; and
determining that the first device operates in the mode when the signal strength is larger than the threshold.

15. The first device of claim 11, wherein the processor is further configured to determine whether the first device operates in the mode by:
establishing a wireless link between the first device and the second device;
determining a round-trip time (RTT) value of an RF signal transmitted by the first device;
comparing the RTT with a threshold value; and
determining that the first device operates in the mode when the RTT is less than the threshold value.

16. The first device of claim 11, wherein the processor is further configured to determine whether the first device operates in the mode by:
determining an energy of an audio signal transmitted by the second device;
comparing the energy of the audio signal with a threshold; and
determining that the first device operates in the mode when the energy of the audio signal is greater than the threshold value.

17. The first device of claim 11, wherein the processor is further configured to determine whether the first device operates in the mode by:
determining that the second device is being charged by the first device; and
determining that the first device operates in the mode when the second device is being charged by the first device.

18. The first device of claim 11, wherein the processor is further configured to determine whether the first device operates in the mode by:
determining the first device and the second device are being charged by a charging device; and
determining that the first device operates in the mode when the first device and the second device are being charged by the charging device.

19. The first device of claim 11, wherein the processor is further configured to:
convert the RF signals between the first device and the second device to channel impulse response (CIR);
determine that a human is within a threshold distance based on the CIR; and
display information associated with a battery level of the first device when the human is within the threshold distance.

20. The first device of claim 19, wherein the processor is further configured to:
determine, using a camera on the first device, an identity of the human using a face recognition process; and
display information based on the identity of the human.
